(19) United States
(12) Patent Application Publication
(10) Pub. No.: US 2012/0166216 A1
(43) Pub. Date: Jun. 28, 2012

(54) SYSTEM AND METHOD FOR MANAGING MEDICATION

(75) Inventors: Myung Eun LIM, Daejeon (KR); Jae Hun CHOI, Daejeon (KR); Dae Hee KIM, Daejeon (KR); Soo Jun PARK, Seoul (KR)

(73) Assignee: Electronics and Telecommunications Research Institute, Daejeon (KR)

(21) Appl. No.: 13/335,277

(22) Filed: Dec. 22, 2011

(30) Foreign Application Priority Data
Dec. 23, 2010 (KR) 10-2010-0133905

(51) Int. Cl. G06Q 50/22; G06K 9/00

(52) U.S. Cl. 705/2; 382/103

(57) ABSTRACT

Disclosed are a system and method for managing medication. In detail, a user terminal notifies a user of taking medicine and recognizes whether the medicine has been taken by receiving a medication schedule corresponding to an identification code of prescription from a medication management server or generating the medication schedule for itself to thereby interoperate with a medication support device, or the user terminal recognizes whether the medicine has been taken by using a medicine packet and a medicine content area without depending on the medication support device so that a user may easily take a medicine according to the medication schedule and a medication management service may be provided through the user terminal even when the user goes out or moves.

### CROSS-REFERENCE TO RELATED APPLICATIONS

This application is based on and claims priority from Korean Patent Application No. '10-2010-0133905, filed on Dec. 23, 2010, with the Korean Intellectual Property Office, the disclosure of which is incorporated herein in its entirety by reference.

### TECHNICAL FIELD

The present disclosure relates to a system and method for managing medication, and more particularly, to a system and method for helping a user easily take a medicine according to a medication schedule and providing a medication management service through a user terminal even when the user goes out or moves, for which the user terminal notifies the user of taking medicine and recognizes whether the medicine has been taken by receiving the medication schedule corresponding to an identification code of prescription from a medication management server or generating the medication schedule for itself to thereby interoperate with a medication support device, or the user terminal recognizes whether the medicine has been taken by using a medicine packet and a medicine content area without depending on the medication support device.

### BACKGROUND

It is important to regularly take a medicine for managing a chronic disease such as hypertension or cardiac disorder. However, old people who need to take a medicine frequently forget to take a medicine due to a memory limitation. For this reason, a technique such as a medication monitoring technique is needed for supporting a regular medication.

The medication supporting technique is required to provide a function of medication notification for instructing a user to take a medicine at a correct time and a function of medication recognition for recognizing whether the medicine actually has been taken without a limitation in place.

A conventional medication device for supporting medication is described below. As the convention medication device, there are a medicine box to which an alarm watch is attached, and a smart medication device for storing medicines, notifying times for taking medicines, and detecting whether medicines have been taken. The alarm-type medicine box is portable. However, the alarm-type medicine box cannot actively cope with a change of medication status of a user, and cannot detect whether a medicine has been taken.

The smart medication device may appropriately change a medication notification and detect whether a medicine has been taken. However, the smart medication device is not portable. Using another technique, the medication notification may be managed through a cell phone. However, it cannot be detected whether a medicine has been taken.

### SUMMARY

The present disclosure has been made in an effort to provide a system and method for helping a user easily take a medicine according to a medication schedule and providing a medication management service through a user terminal even when the user goes out or moves, for which the user terminal notifies the user of taking medicine and recognizes whether the medicine has been taken by receiving the medication schedule corresponding to an identification code of prescription from a medication management server, or generates the medication schedule for itself to thereby interoperate with a medication support device, or the user terminal recognizes whether the medicine has been taken by using a medicine packet and a medicine content area without depending on the medication support device.

An exemplary embodiment of the present disclosure provides a medication management system including: a user terminal configured to recognize and transmit an identification code of an issued prescription, and receive a medication schedule corresponding to the transmitted identification code to notify a user of taking a medicine and recognize whether the medicine is taken; a medication management server configured to receive the transmitted identification code to generate the medication schedule and transmit the generated medication schedule to the user terminal; and a medication support device configured to store medicines corresponding to the issued prescription, and discharges the stored medicines to the user according to the medication schedule to support medication, wherein the medication management server and the user terminal synchronize a result of the recognition.

Another exemplary embodiment of the present disclosure provides a user terminal for managing a medication including: a communication unit configured to communicate with a medication management server; an identification code recognition unit configured to recognize an identification code of an issued prescription for a user; a medication schedule management unit configured to transmit the recognized identification code to the medication management server through the communication unit, and receive a medication schedule; a medication notification unit configured to notify the user of taking a medicine according to the received medication schedule; and a medication recognition unit configured to recognize whether the user takes the medicine corresponding to the medication notification by interoperating with a medication support device, or by processing an image of a medicine packet.

Yet another exemplary embodiment of the present disclosure provides a medication management method for a user terminal, including: recognizing an identification code of an issued prescription; transmitting the recognized identification code to a medication management server; receiving a medication schedule corresponding to the transmitted identification code from the medication management server; notifying a user of taking a medicine according to the received medication schedule; and checking whether the user takes the medicine corresponding to the medication notification.

Still another exemplary embodiment of the present disclosure provides a medication management method for a user terminal, including: acquiring an image of a medicine packet by photographing the medicine packet; detecting an outline of the acquired image of the medicine packet; and detecting contour lines within the detected outline of the medicine packet; recognizing a medication status by checking whether a tear line or a medication content area exists on the detected contour lines of the medicine packet.

According to the exemplary embodiments of the present disclosure, a user terminal notifies a user of taking medicine and recognizes whether the medicine has been taken by receiving a medication schedule corresponding to an identification code of prescription from a medication management server or generating the medication schedule for itself to thereby interoperate with a medication support device, or the user terminal recognizes whether the medicine has been taken by using a medicine packet and a medicine content area without depending on the medication support device so that a user can easily take a medicine according to the medication schedule and a medication management service can be provided through the user terminal even when the user goes out or moves.

That is, according to the exemplary embodiments of the present disclosure, medication can be managed by interoperating with the medication support device which controls discharge of a medicine and recognizes whether a medicine is taken for medicines packaged in a medicine packet. According to the exemplary embodiments of the present disclosure, medication support service can be provided more intimately and correctly by providing medication service even when a patient goes out or moves by recognizing whether a medicine is taken on the basis of status of medicine packet and medicine content without depending on the medication support device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a medication management system according to an exemplary embodiment of the present disclosure.

FIG. 2 is a block diagram illustrating a user terminal for the medication management according to an exemplary embodiment of the present disclosure.

FIG. 3 is a flowchart illustrating a medication management method in the user terminal according to a first exemplary embodiment of the present disclosure.

FIG. 4 is a flowchart illustrating the medication management method in the user terminal according to a second exemplary embodiment of the present disclosure.

FIG. 5 is a flowchart illustrating a medication support method for the medication support device according to an exemplary embodiment of the present disclosure.

FIG. 6 is a flowchart illustrating a medication recognition method in the user terminal according to an exemplary embodiment of the present disclosure.

FIG. 7 is an exemplary diagram illustrating the medicine packet outline extracted by the medicine packet image analysis according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Before describing the present disclosure, medicines prescribed by doctors are prepared and packaged in various forms in a pharmacy. Generally, the medicines are wrapped in a vinyl or paper medicine packet for preventing the medicines from being contaminated. Therefore, it is assumed that the medicine as an object to be recognized for supporting medication is packaged in a medicine packet. However, the object is not limited thereto.

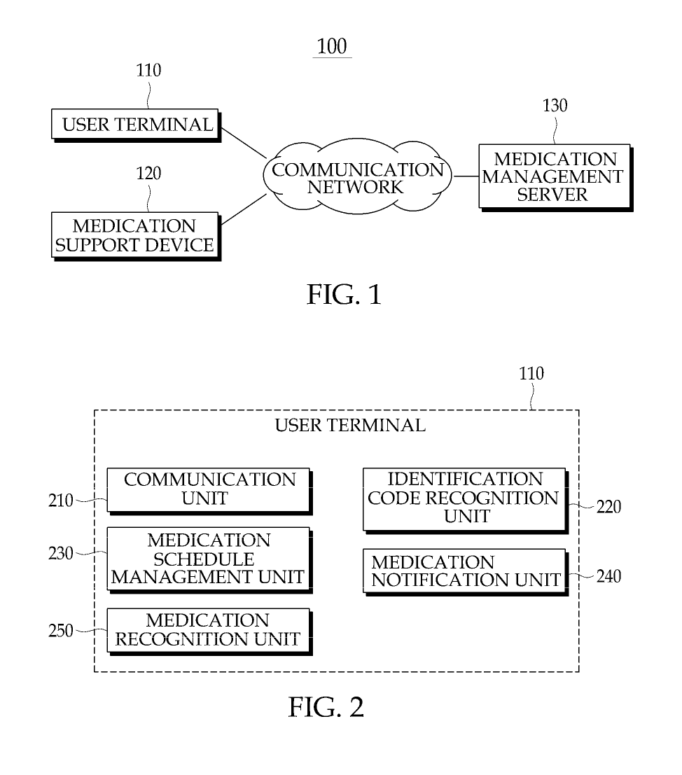

FIG. 1 is a block diagram illustrating a medication management system according to an exemplary embodiment of the present disclosure.

As illustrated in FIG. 1, a medication management system 100 includes a user terminal 110, a medication support device 120, and a medication management server 130.

Medication management system 100 is for reminding a user to take a medicine at a predetermined medicine taking time. To this end, user terminal 110 having a camera and communication function includes functions of medication notification and medication status recognition to thereby monitor a medication status.

User terminal 110 according to a first exemplary embodiment of the present disclosure is described below.

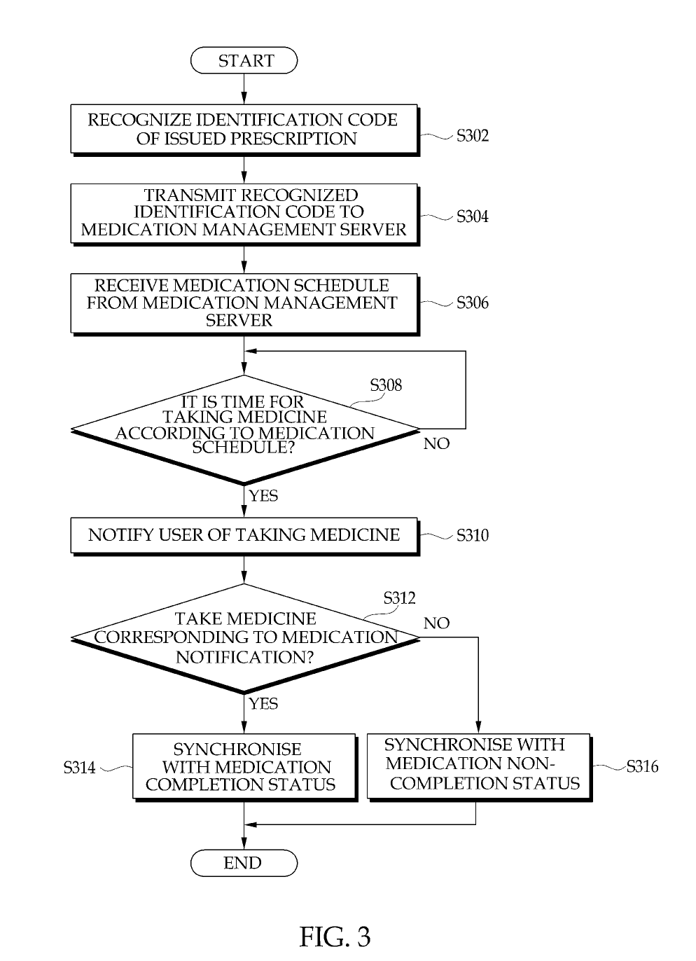

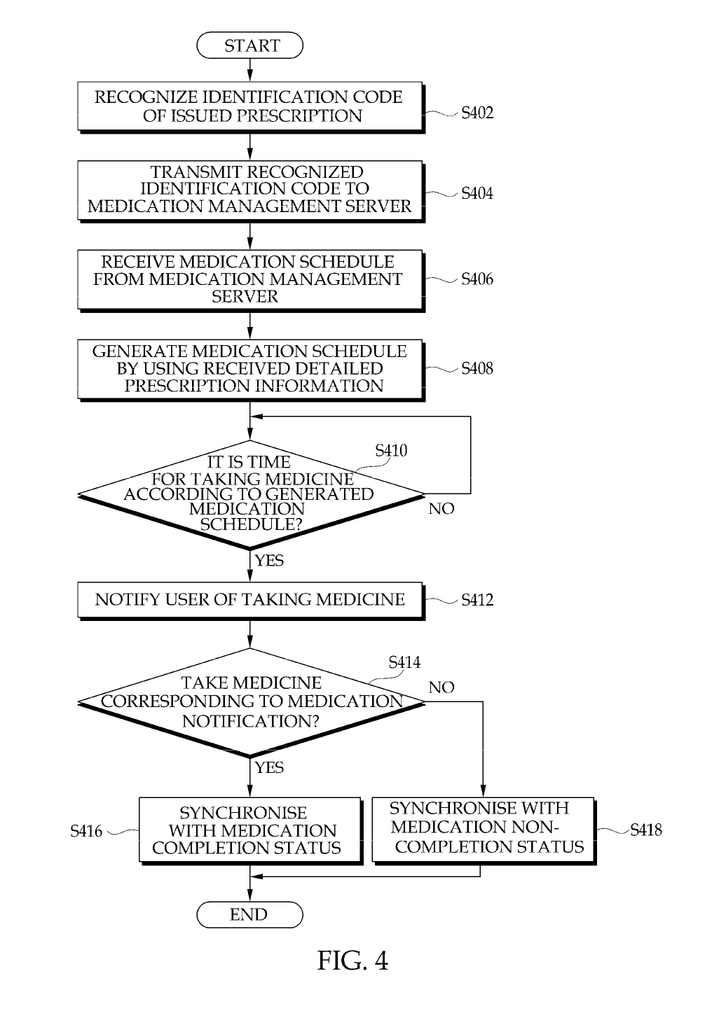

According to the first exemplary embodiment, user terminal 110 interoperates with medication support device 120, which controls discharge of prescribed medicines packaged in medicine packets and recognizes taking medicine, to thereby mange medication of the user. A method for this medication management will be described in detail with reference to FIGS. 3 and 4.

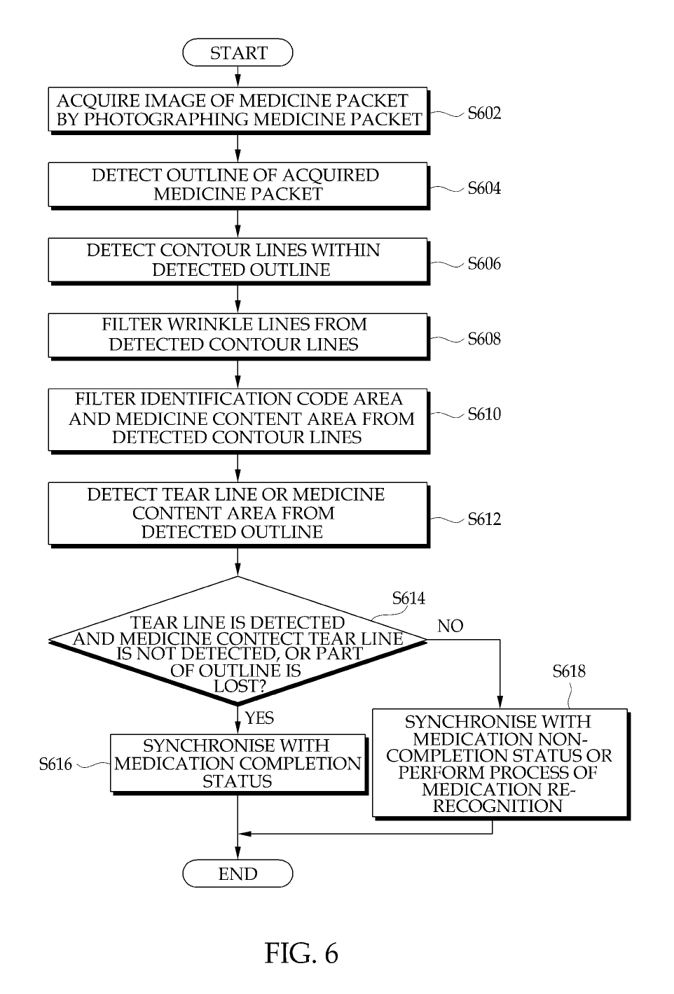

According to a second exemplary embodiment of user terminal 110, user terminal 110 may recognize taking medicine on the basis of status of the medicine packet and contents thereof to provide a medication management service even when the user goes out or moves without depending on medication support device 120. In this manner, user terminal 110 may provide the medication management server to the user more intimately and correctly. A method for this medication management will be described in detail with reference to FIG. 6.

Hereinafter, components of medication management system 110 according to an exemplary embodiment of the present disclosure will be described in detail.

User terminal 110 is always carried by the user and registers a prescription of medicines. User terminal 110 may receive a medication schedule corresponding to the registered prescription from medication management server 130, or may receive detailed prescription information from medication management server 130 to generate a medication schedule. Herein, user terminal 110 may store the medication schedule received from medication management server 130 or generated for itself in a built-in memory to manage the medication schedule.

User terminal 110 notifies the user of taking medicine according to the medication schedule. Thereafter, user terminal 110 recognizes whether a medicine is taken or not taken, and synchronizes the medication status with medication management server 130 and medication support device 120. Herein, user terminal 110 may recognize whether a medicine is taken or not taken by analyzing an image on the medicine packet.

Medication management server 130 provides a medication management service, and manages data about prescriptions and the medication status. Medication management server 130 receives an identification code corresponding to the prescription from user terminal 110, and generates the medication schedule on the basis of the received identification code. Medication management server 130 transmits the detailed prescription information to user terminal 110 on the basis of the received identification code. Medication management server 130 stores the prescription and total medication schedules, and receives the medication status from user terminal 110 or medication support device 120 to manage and synchronize the medication status.

Medication support device 120 provides a service as a medicine box for storing prescribed medicines. Medication support device 120 may control taking of medicine by discharging a medicine for the user only when the medication notification is provided to the user or the user goes out. Herein, for the medication management service, it is preferable that a medicine is provided after the prescription is registered. In the case of using medication support device 120, medicines may be stored in medication support device 120. In the case that a medicine is discharged from medication support device 120, medication support device 120 may be synchronized with user terminal 110 or medication management server 130 periodically or in real time.

Meanwhile, user terminal 110 or medication support device 120 may provide the medication notification to the user through a screen (e.g., LCD or the like), letters, sound or voice, and an LED.

FIG. 2 is a block diagram illustrating a user terminal for the medication management according to an exemplary embodiment of the present disclosure.

As illustrated in FIG. 2, the user terminal includes a communication unit 210, an identification code recognition unit 220, a medication schedule management unit 230, a medication notification unit 240, and a medication recognition unit 250.

Communication unit 210 performs a communication operation with medication management server 130 or medication support device 120. Communication unit 210 communicates with medication management server 130 to transmit the prescription or receive the detailed prescription information or medication schedule. Communication unit 210 transmits/receives medication status data to be synchronized with medication management server 130 or medication support device 120.

Identification code recognition unit 220 may recognize the medicine packet and the identification code according to the prescription issued from a hospital or pharmacy. For instance, identification code recognition unit 220 may recognize the identification code by reading one or two-dimensional bar code or RFID bar code attached on the prescription through a bar code sensor or tag reader. Herein, it is assumed that the identification code is attached or printed on the prescription for uniquely identifying the prescription. As described above, the identification code may be the one or two-dimensional bar code or RFID, but is not limited thereto. The identification code is issued by a drug utilization review (DUR) system or a medical server which generates and manages identification codes for itself. The identification code includes information about medicines to be taken, period for taking medicines, and the number of times of taking medicines per day so that user terminal 110 may check the detailed prescription information or receive the medication schedule through medication management server 130.

Medication schedule management unit 230 registers the prescription recognized by identification code recognition unit 220, and transmits the prescription recognized through communication unit 110 to medication management server 130. Medication schedule management unit 230 may receive the medication schedule from communication unit 110 or receive the detailed prescription information to generate and manage the medication schedule.

Medication notification unit 240 provides the medication notification to the user according to the medication schedule managed by medication schedule management unit 230. Medication notification unit 240 may expresses the medication notification message for the user according to time in the medication schedule. Herein, the medication notification may be selectively repeated before a preset time limit for taking medicine elapses.

Medication recognition unit 250 recognizes whether the user has taken or has not taken a medicine. For instance, medication recognition unit 250 may check whether medication support device 130 discharges a medicine for the user. Medication recognition unit 250 may recognize taking of medicine by recognizing a shape of a torn medicine packet to be taken according to the medication schedule and recognizing contents of the medicine packet.

FIG. 3 is a flowchart illustrating a medication management method in the user terminal according to a first exemplary embodiment of the present disclosure.

Identification code recognition unit 220 recognizes the identification code of the prescription issued for the user in operation S302. The user may place the identification code attached on the prescription near user terminal 110 to input the identification code to user terminal 110. For instance, identification code recognition unit 220 may recognize the bar code-type identification code through a scanner, or may recognize the RFID-type identification code through a reader.

Communication unit 210 transmits the identification code recognized by identification code recognition unit 220 to medication management server 130 in operation S304.

Meanwhile, medication management server 130 may previously collect the detailed prescription information from the DUR system or the medical server which generates and manages identification codes for itself. If the identification code of the prescription recognized by user terminal 110 is received, the medication schedule corresponding to the received identification code is generated.

Communication unit 210 receives the medication schedule from medication management server 130 in operation S306. Medication schedule management unit 230 stores the received medication schedule in a memory to manage the received medication schedule.

Medication schedule management unit 230 checks whether it is time for taking a medicine according to the medication schedule in operation S308.

According to a result of the check in operation S308, if it is time for taking a medicine, medication notification unit 240 notifies the user of taking medicine according to the medication schedule in operation S310. On the contrary, if it is not time for taking a medicine, operations are repeated from operation S308.

Thereafter, medication recognition unit 250 checks whether the user takes a medicine corresponding to the medication notification of operation S310, in operation S312.

According to a result of the check in operation S312, if a medicine has been taken corresponding to the medication notification, medication recognition unit 250 with the medication completion status is synchronized with medication management server 130 or medication support device 120 in operation S314.

According to a result of the check in operation S312, if a medicine has not been taken corresponding to the medication notification, medication recognition unit 250 with the medication non-completion status is synchronized with medication management server 130 or medication support device 120 in operation S316.

FIG. 4 is a flowchart illustrating the medication management method in the user terminal according to a second exemplary embodiment of the present disclosure.

Identification code recognition unit 220 recognizes the identification code of the prescription issued for the user in operation S402.

Communication unit 210 transmits the identification code recognized by identification code recognition unit 220 to medication management server 130 in operation S404.

Meanwhile, medication management server 130 may previously collect the detailed prescription information from the DUR system or the medical server which generates and manages identification codes for itself. If the identification code of the prescription recognized by user terminal 110 is received, the medication schedule corresponding to the received identification code is previously collected and transmitted to user terminal 110.

Communication unit 210 receives the detailed prescription information from medication management server 130 in operation S406. For generating a detailed schedule, the detailed prescription information includes a starting date of taking medicine, ending date of taking medicine, the number of times of taking medicine and specific times for taking medicine, and method of taking medicine.

Medication schedule management unit 230 generates the medication schedule by using the received detailed prescription information in operation S408. Thereafter, medication schedule management unit 230 stores the generated medication schedule in a memory to manage the generated medication schedule.

Medication schedule management unit 230 checks whether it is time for taking a medicine according to the medication schedule in operation S410.

According to a result of the check in operation S410, if it is time for taking a medicine, medication notification unit 240 notifies the user of taking medicine according to the medication schedule in operation S412. On the contrary, if it is not time for taking a medicine, operations are repeated from operation S410.

Thereafter, medication recognition unit 250 checks whether the user takes a medicine corresponding to the medication notification of operation S412, in operation S414.

According to a result of the check in operation S414, if a medicine has been taken corresponding to the medication notification, medication recognition unit 250 with the medication completion status is synchronized with medication management server 130 or medication support device 120 in operation S416.

According to a result of the check in operation S414, if a medicine has not been taken corresponding to the medication notification, medication recognition unit 250 with the medication non-completion status is synchronized with medication management server 130 or medication support device 120 in operation S418.

The methods described above with reference to FIGS. 3 and 4 may be performed through user terminal 110 after a medication management application is downloaded from medication management server 130 and installed on user terminal 110 after medicines are prepared according to the prescription for the user. The user may run the downloaded medication management application to register the prescription, receive the medication notification, or update the medication status.

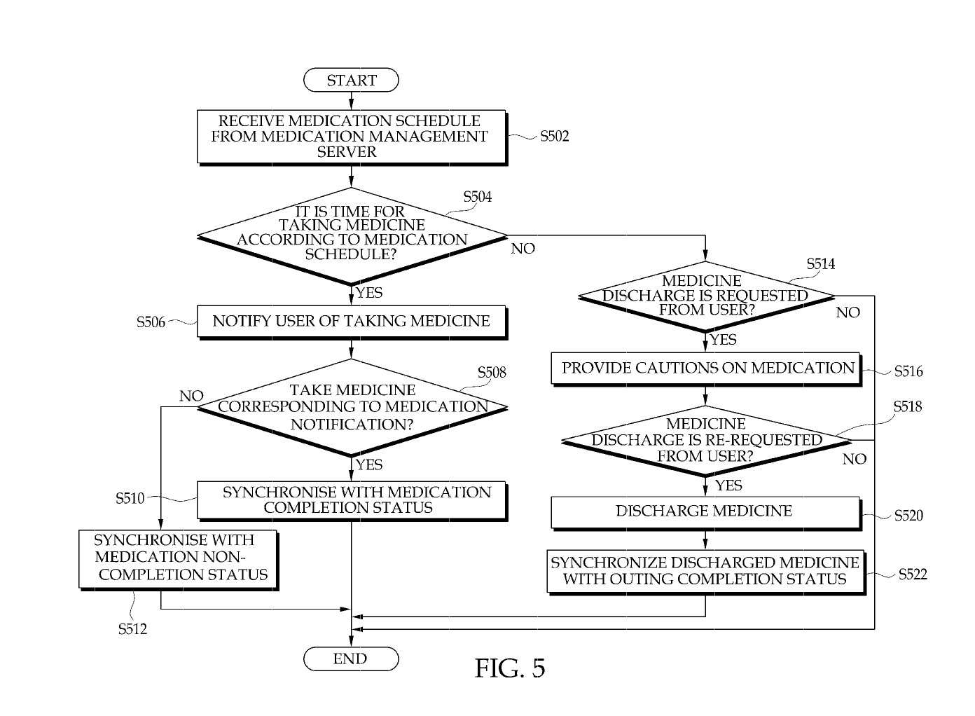

FIG. 5 is a flowchart illustrating a medication support method for the medication support device according to an exemplary embodiment of the present disclosure.

Hereinafter, the method of supporting medication through medication support device 120 will be described below.

Medication support device 120 stores medicines in a medicine box provided to the medication support device 120. Herein, a basic medication notification is provided through medication support device 120.

Medication support device 120 receives the medication schedule from medication management server 130 in operation S502.

Medication support device 120 checks whether it is time for providing the medication notification according to the medication schedule in operation S504.

According to a result of the check in operation S504, if it is time for providing the medication notification, medication support device 120 notifies the user of taking medicine corresponding to the medication schedule in operation S506.

Medication support device 120 checks whether the user take a medicine corresponding to the medication notification in operation S508. This operation is for preventing the user from misconceiving another medicine as the medicine that the user should takes.

According to a result of the check in operation S508, if the user has taken the medicine corresponding to the medication notification, medication support device 120 with the medication completion status is synchronized with user terminal 110 or medication management server 130 in operation S510.

On the contrary, according to a result of the check in operation S508, if the user has not taken the medicine corresponding to the medication notification, medication support device 120 with the medication non-completion status is synchronized with user terminal 110 or medication management server 130 in operation S512. That is, for the medicine which is not taken even after the medicine taking time elapses, medication support device 120 with the medication non-completion status may be synchronized with medication management server 130.

Meanwhile, according to a result of the check in operation S504, if it is not time for providing the medication notification, medication support device 120 checks whether the user requests for medication discharge in operation S514.

According to a result of the check in operation S514, if the user requests for medicine discharge, medication support device 120 provides medication cautions on the requested medicine in operation S516. On the contrary, if the user does not request for medicine discharge, medication support device 120 terminates the medication support process. Herein, if the user tries to discharge a medicine even when it is not time for taking a medicine, medication support device 120 provides medication cautions through first check as described in operations S514 and S516.

Medication support device 120 checks whether the user re-requests for medicine discharge in operation S518.

According to a result of the check in operation S518, if the user re-requests for medicine discharge, medication support device 120 discharges the requested medicine in operation S520. On the contrary, if the user does not re-request for medicine discharge, medication support device 120 terminates the medication support process.

Medication support device 120 with the outing completion status for the discharged medicine is synchronized with user terminal 110 or medication management server 130 in operation S522. In the case that the user tries to discharge a medicine again, medication support device 120 may consider that the user intends to use the medicine during an outing, and may update an outing medicine discharge status of user terminal 110 or medication management server 120 at the same time when the medicine is discharged. If the medication support device 120 transmits the medication schedule updated as outing medication discharge status to medication management server 130, medication management server 130 transmits the schedule changed to outing medicine discharge status to user terminal 110 so that the medication notification is provided for the medicine discharged for an outing.

FIG. 6 is a flowchart illustrating a medication recognition method in the user terminal according to an exemplary embodiment of the present disclosure.

FIG. 6 illustrates the medication recognition method for supporting medication through user terminal 110 without using medication support device 120. In the case of not using medication support device 120, the medicine outing status does not exist. The medication notification is provided through user terminal 110. After providing the medication notification, user terminal 110 may check whether a medicine has been taken by analyzing an image of the medicine packet photographed by the user to update the medication status for medication management server 130.

Medication recognition unit 250 of user terminal 110 photographs the medicine packet taken by the user to acquire a medicine packet image in operation S602. Herein, the medicine packet may be photographed by using the camera provided to user terminal 110.

Medication recognition unit 250 detects an outline of the acquired medicine packet image in operation S604. That is, medication recognition unit 250 may detect an overall outline of the medicine packet from the medicine packet image.

After detecting the outline, a tear line, a wrinkle line, and content area of medicine within the outline of the medicine packet are detected. In detail, medication recognition unit 250 detects contour lines within the detected outline in operation S606.

Medication recognition unit 250 filters wrinkle lines among the detected contour lines of the medicine packet in operation S608. Medication recognition unit 250 considers short lines among the contour lines detected in operation S606 as wrinkle lines, and relatively long lines longer than a critical value as tear line. Herein, medication recognition unit 250 filters wrinkle lines which are highly possibly generated due to simple wrinkle of the medicine packet.

Medication recognition unit 250 filters an identification code area and a letter area within the detected outline of the medicine packet in operation S610. Generally, a text such as a pharmacy name is printed on the medicine packet. For eliminating this, medication recognition unit 250 may further perform operation S610 for filtering the letter area by applying a letter detection algorithm to an image analysis algorithm.

Medication recognition unit 250 detects the tear line or medicine content area among the detected contour lines. Herein, for the user to take a medicine, a certain length of line of the medicine packet should be torn, and thus, the tear line is generated. The medicine content area is detected when the medicine packet is transparent or translucent and the medicine has not be taken by the user. The medicine content area is not detected when the medicine has been taken or the medicine packet is opaque. The identification code such as a bar code may be printed. In this case, medication recognition unit 250 may detect the tear line or medicine content area by excluding the identification code area recognized by identification code recognition unit 220.

Medication recognition unit 250 detects whether the tear line is detected and the medicine content area is not detected, or whether an overall outline form is not maintained and a partial outline is lost unlike a normal packet in operation S614.

According to a result of the check in operation S614, in the case that the tear line is detected and the medicine content area is not detected, or a partial outline is lost without maintaining an overall outline, medication recognition unit 250 considers that a medicine has been taken, and is synchronized with medication management server 130. On the contrary, according to a result of the check in operation S614, in the case that the tear line is not detected and the medicine content area is detected, medication recognition unit 250 considers that a medicine has not been taken, and is synchronized with medication management server 130. That is, medication recognition unit 250 may consider that a medicine has been taken when the tear line exists and the medicine content area is not detected.

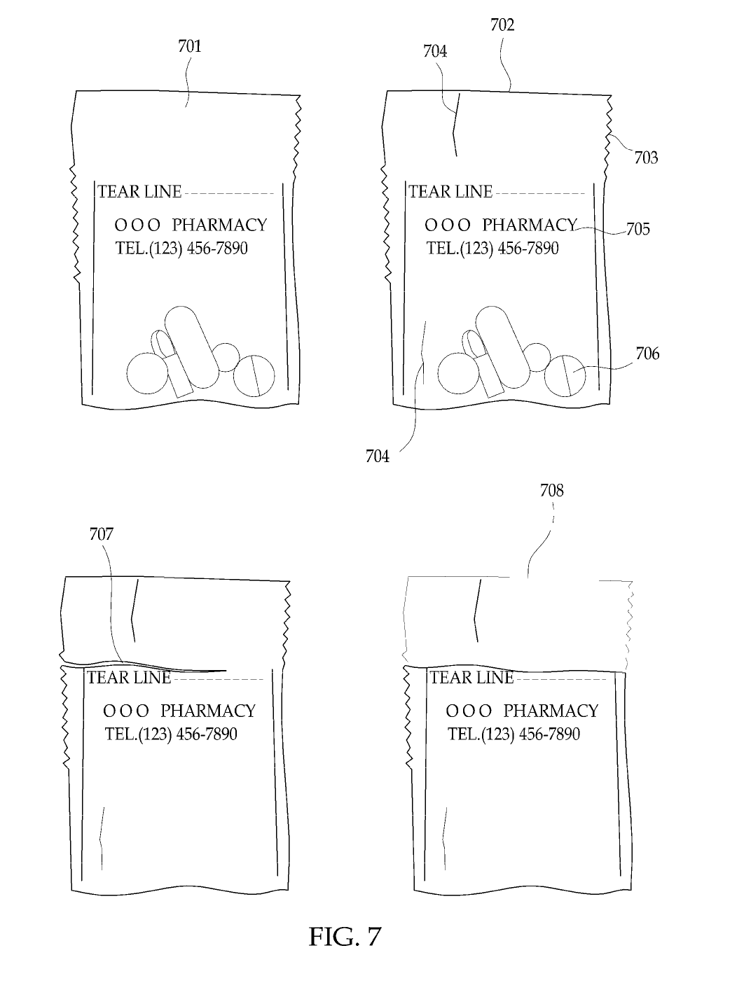

FIG. 7 is an exemplary diagram illustrating the medicine packet outline extracted by the medicine packet image analysis according to an exemplary embodiment of the present disclosure.

Photographed medicine packet image 701 is extracted to a simplified medicine packet image 702 through operation S604 for detecting an outline 703 and operation S606 for detecting the contour line. In the simplified medicine packet image 702, lines within the outline 703 are classified to a wrinkle line 704, a letter and identification code area 705, a medicine content area 706, and a tear line 707. Herein, medication recognition unit 250 considers that a medicine has been taken when the tear line 707 is detected and the medicine content area 706 is not detected, or when a partial outline is lost (708).

Meanwhile, the above-described medication management method may be realized as a software program to be recorded on a computer readable recording medium, and thus may be applied to various reproducing devices.

The various reproducing devices may include a mobile terminal as the above described user terminal, a PDA, a notebook computer, a navigator, a PMP, a smartphone, an electronic dictionary, and an MPS.

For instance, the recording medium may include a hard disk, flash memory, RAM, and ROM as a built-in type device for reproducing device, or an optical disk such as CD-R or CD-RW, compact flash card, smart media, memory stick, and multimedia card as an external type device for reproducing device.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A medication management system, comprising:
a user terminal configured to recognize and transmit an identification code of an issued prescription, and receive a medication schedule corresponding to the transmitted identification code to notify a user of taking a medicine and recognize whether the medicine is taken;
a medication management server configured to receive the transmitted identification code to generate the medication schedule and transmit the generated medication schedule to the user terminal; and
a medication support device configured to store medicines corresponding to the issued prescription, and discharges the stored medicines to the user according to the medication schedule to support medication,
wherein the medication management server and the user terminal synchronize a result of the recognition.

2. The system of claim 1, wherein the medication management server transmits previously collected detailed prescription information for the transmitted identification code to the user terminal, and the user terminal receives the detailed prescription information from the medication management server and generates the medication schedule by using the received detailed prescription information.

3. A user terminal for managing a medication, comprising:
a communication unit configured to communicate with a medication management server;
an identification code recognition unit configured to recognize an identification code of an issued prescription for a user;
a medication schedule management unit configured to transmit the recognized identification code to the medication management server through the communication unit, and receive a medication schedule;
a medication notification unit configured to notify the user of taking a medicine according to the received medication schedule; and
a medication recognition unit configured to recognize whether the user takes the medicine corresponding to the medication notification by interoperating with a medication support device, or by processing an image of a medicine packet.

4. The user terminal of claim 3, wherein the communication unit synchronizes a mediation status recognized by the medication recognition unit with the medication management server when the medication status is a medication completion status or a medication non-completion status.

5. The user terminal of claim 3, wherein the medication schedule management unit generates the medication schedule by using detailed prescription information when the detailed prescription information is received from the medication management server.

6. The user terminal of claim 3, wherein the medication recognition unit recognizes a medication completion status or a medication non-completion status according to whether a tear line or a medicine content area exists on contour lines of a medicine packet corresponding to the medication notification.

7. A medication management method for a user terminal, comprising:
recognizing an identification code of an issued prescription;
transmitting the recognized identification code to a medication management server;
receiving a medication schedule corresponding to the transmitted identification code from the medication management server;
notifying a user of taking a medicine according to the received medication schedule; and
checking whether the user takes the medicine corresponding to the medication notification.

8. The method of claim 7, further comprising generating a medication schedule by using detailed prescription information when the detailed prescription information is received from the medication management server, and the notifying of the taking a medicine notifies the user of taking a medicine according to the generated medication schedule.

9. The method of claim 7, further comprising synchronizing the medication management server with a medication completion status or a medication non-completion status according to a result of the checking whether the user takes the medicine.

10. A medication management method for a user terminal, comprising:
acquiring an image of a medicine packet by photographing the medicine packet;
detecting an outline of the acquired image of the medicine packet;
detecting contour lines within the detected outline of the medicine packet; and
recognizing a medication status by checking whether a tear line or a medication content area exists on the detected contour lines of the medicine packet.

11. The method of claim 10, further comprising filtering at least one of a wrinkle line, identification code area, and letter area from the detected contour lines of the medicine packet.

12. The method of claim 10, further comprising synchronizing a medication completion status or a medication non-completion status according to whether the tear line or the medication content area exists on the detected contour lines of the medicine packet.
